(19) United States
(12) Patent Application Publication
(10) Pub. No.: US 2010/0284878 A1
(43) Pub. Date: Nov. 11, 2010

(54) AIR POLLUTION CONTROL SYSTEM AND METHOD FOR COAL COMBUSTION BOILER

(75) Inventors: Nobuyuki Ukai, Hiroshima (JP); Shintaro Honjo, Hiroshima (JP); Susumu Okino, Hiroshima (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 12/863,672

(22) PCT Filed: Jan. 20, 2009
(86) PCT No.: PCT/JP2009/050769

§ 371 Date: Jul. 20, 2010

(30) Foreign Application Priority Data
Jan. 21, 2008 (JP) 2008-010329

(51) Int. Cl. B01D 53/50; B01D 50/00; B01D 53/64

(52) U.S. Cl. 423/242.1; 422/169

(57) ABSTRACT

An air pollution control system for a coal combustion boiler according to the present invention includes: a NOx removing apparatus (13) that removes nitrogen oxide contained in flue gas emitted from this coal combustion boiler (11) by adding ammonia (12) thereto, an air pre-heater (14) that recovers heat in the gas after the nitrogen oxide is removed, a precipitator (15) that reduces particulates from the gas after the heat is recovered, a gas-liquid contact type SOx removing apparatus (16) that removes sulfur oxide by way of a limestone-gypsum method and reduces mercury oxide in the gas after the particulates are reduced, and a stack (17) that releases purified gas after the sulfur and the mercury are reduced, where an oxidant is added to limestone-gypsum containing slurry (21) in or extracted from the SOx removing apparatus (16).

### TECHNICAL FIELD

The present invention relates to an air pollution control system and an air pollution control method both of which are for a coal combustion boiler that reduces mercury contained in flue gas from the boiler.

### BACKGROUND ART

Due to the fact that flue gas emitted from a boiler, such as one that is a combustor in a thermal power plant, for example, contains highly toxic mercury, various systems for reducing mercury contained in the flue gas have been developed.

A boiler typically includes a wet-type SOx removing apparatus for removing sulfur contained in the flue gas. It is widely known that, in an air pollution control facility including such a boiler having the SOx removing apparatus provided thereto as an air pollution control apparatus, the SOx removing apparatus can readily collect the mercury because divalent mercury oxide is water-soluble.

Various inventions related to a method or an apparatus for controlling metallic mercury by combining a NOx removing apparatus that removes NOx and the wet-type SOx removing apparatus that uses an alkali absorbent as a SOx absorbent have been devised recently (Patent Document 1).

A reducing method using an adsorbent such as activated carbon or a selenium filter is commonly known as a method for controlling metallic mercury contained in flue gas. However, because such a method requires a special adsorbing-reducing unit, the method is not suited for controlling a large volume of flue gas from a power plant, for example.

As a method for controlling metallic mercury contained in a large volume of flue gas, a limestone-gypsum method using a gas-liquid contact type SOx removing apparatus has been widely employed as a method for reducing SOx through reactions expressed by formulas (1) and (2) below:

SO₂+CaCO₃+1/2H₂O→CaSO₃.1/2H₂O+CO₂ (absorption) (1)

CaSO₃.1/2H₂O+3/2H₂O+1/2O₂→CaSO₄.2H₂O (oxidization) (2)

[Patent Document 1] Japanese Patent Laid-open No. 2007-7612

### DISCLOSURE OF INVENTION

### Problem to be Solved by the Invention

In the gas-liquid contact type SOx removing apparatus, mercury oxide (Hg²⁺) had been adsorbed to and immobilized by gypsum slurry absorbent (hereinafter, also referred to as “slurrys” or “slurry absorbent”) to reduce mercury. At this time, the speed of reducing mercury (Hg) generally depends on the speed of gypsum (CaSO₄) generation.

Therefore, to increase the speed of mercury reduction, it is necessary to increase the speed of gypsum (CaSO₄) generation; however, because the ratio of mercury (Hg) and sulfur (S) contained in a coal depends on the properties of the coal, it is difficult to increase only the speed of gypsum generation.

Therefore, if the amount of gypsum produced in the slurry containing gypsum-limestone is small when using a coal containing less sulfur (S) with respect to mercury (Hg), the performance of mercury (Hg) reduction might be insufficient.

In addition, air or oxygen-enriched air is added to keep the slurry oxidized, to prevent mercury oxide (Hg²⁺) from being reduced (Hg²⁺→Hg⁰), and to prevent the re-emission of zero-valent mercury) (Hg⁰) to a gaseous phase.

However, if the flue gas contains a large volume of reducing substance, a predetermined level of oxidization (oxidation-reduction potential (ORP) of equal to or more than +150 millivolts) may not be maintained, and the re-emission of zero-valent mercury) (Hg⁰) to the gaseous phase may not be suppressed. Therefore, it is desirable to reduce mercury contained in flue gas effectively by way of other countermeasures.

In consideration of the above, an object of the present invention is to provide an air pollution control system and an air pollution control method both of which are for a coal combustion boiler capable of effectively reducing mercury contained in flue gas emitted from the coal combustion boiler.

### Means for Solving Problem

According to an aspect of the present invention, an air pollution control system for a coal combustion boiler includes: a NOx removing apparatus that removes nitrogen oxide contained in flue gas emitted from the coal combustion boiler; an air pre-heater that recovers heat in the gas after the nitrogen oxide is removed; a precipitator that reduces particulates from the gas after the heat is recovered; a liquid-gas contact type SOx removing apparatus that removes sulfur oxide by way of a limestone-gypsum method and reduces mercury oxide in the gas after the particulates are reduced; and a stack that releases gas after SOx removal. An oxidant is added to limestone-gypsum containing slurry.

Advantageously, in the air pollution control system for a coal combustion boiler, the oxidant is one of or any combination of a manganese compound, ozone, hydrogen peroxide, and a chlorine-based compound, and an oxidation-reduction potential is equal to or more than 150 millivolts.

According to another aspect of the present invention, an air pollution control method for a coal combustion boiler by using a liquid-gas contact type SOx removing apparatus that removes sulfur oxide by way of a limestone-gypsum method and reduces mercury oxide contained in flue gas emitted from the coal combustion boiler includes: adding an oxidant to limestone-gypsum containing slurry.

Advantageously, in the air pollution control method for a coal combustion boiler, the oxidant is one of or any combination of a manganese compound, ozone, hydrogen peroxide, and a chlorine-based compound, and an oxidation-reduction potential is equal to or more than 150 millivolts.

### Effect of the Invention

According to the present invention, re-emission of mercury from the gas-liquid contact slurry absorbent is eliminated, the contact efficiency between the mercury in the flue gas and the gypsum can be improved, and the adsorption and the immobilization of the mercury can be promoted.

### BRIEF DESCRIPTION OF DRAWINGS

FIG. 1 is a schematic of an air pollution control system according to an embodiment of the present invention.

FIG. 2 is a graph indicating a relationship between a mercury re-emission rate (%) and an ORP oxidation-reduction potential (mV).

### EXPLANATIONS OF LETTERS OR NUMERALS

11 coal combustion boiler
12 ammonia
13 NOx removing apparatus
14 air pre-heater
15 precipitator
16 SOx removing apparatus
17 stack
21 limestone-gypsum containing slurry
22 solid-liquid separator
23 filtrate
24 gypsum

### BEST MODE(S) FOR CARRYING OUT THE INVENTION

The present invention will now be explained in detail with reference to the drawings. An embodiment of the present invention disclosed herein is not intended to limit the scope of the present invention in any way. Furthermore, elements disclosed in the embodiment include elements that can be easily thought of by those skilled in the art and elements that are substantially identical.

### Embodiment

An air pollution control system for a coal combustion boiler according to an embodiment of the present invention will now be explained with reference to the drawings.

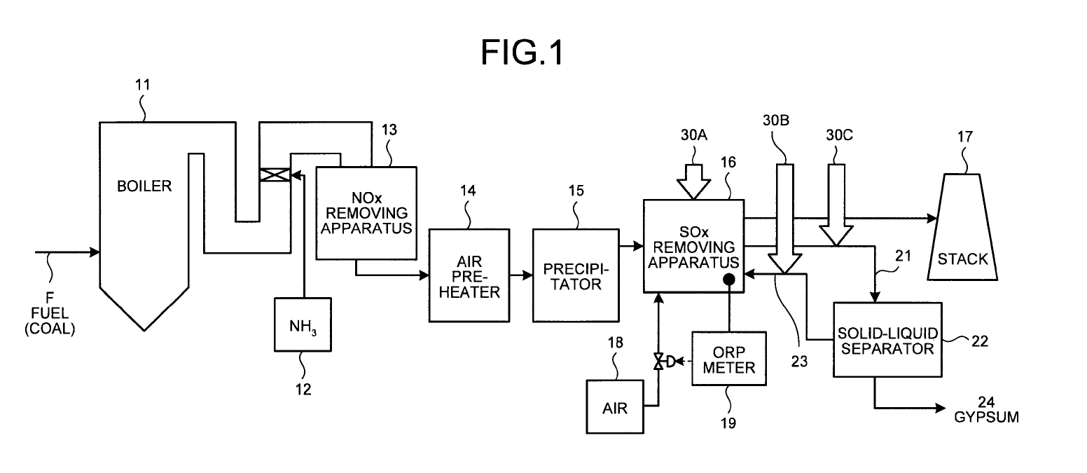

FIG. 1 is a schematic of the air pollution control system for the coal combustion boiler according to the embodiment. As shown in FIG. 1, the air pollution control system according to the embodiment includes: a NOx removing apparatus 13 that removes nitrogen oxide contained in flue gas emitted from a coal combustion boiler 11 to which coal is supplied as a fuel F by adding ammonia 12 to the flue gas, an air pre-heater 14 that recovers heat in the gas after the nitrogen oxide is removed, a precipitator 15 that reduces particulates from the gas after the heat is recovered, a liquid-gas contact type SOx removing apparatus 16 that removes sulfur oxide by way of the limestone-gypsum method and reduces mercury oxide in the gas after the particulates are reduced, and a stack 17 that releases purified gas after the sulfur and the mercury are reduced to the exterior, where an oxidant is added to limestone-gypsum containing slurry 21 in or extracted from the SOx removing apparatus 16.

In the drawing, the reference numeral 18 denotes air; the reference numeral 19 denotes an oxidation-reduction potential measuring meter (ORP meter); the reference numeral 22 denotes a solid-liquid separator for separating a gypsum 24; and the reference numeral 23 denotes filtrate having gypsum reduced.

The oxidant may be added to a gas-liquid contactor (30A), or an upstream side (30B) or a downstream side (30C) of the solid-liquid separator 22.

In addition, it is preferable to keep the oxidation-reduction potential in the slurry absorbent equal to or more than 150 millivolts in the SOx removing apparatus by supplying the oxidant thereto.

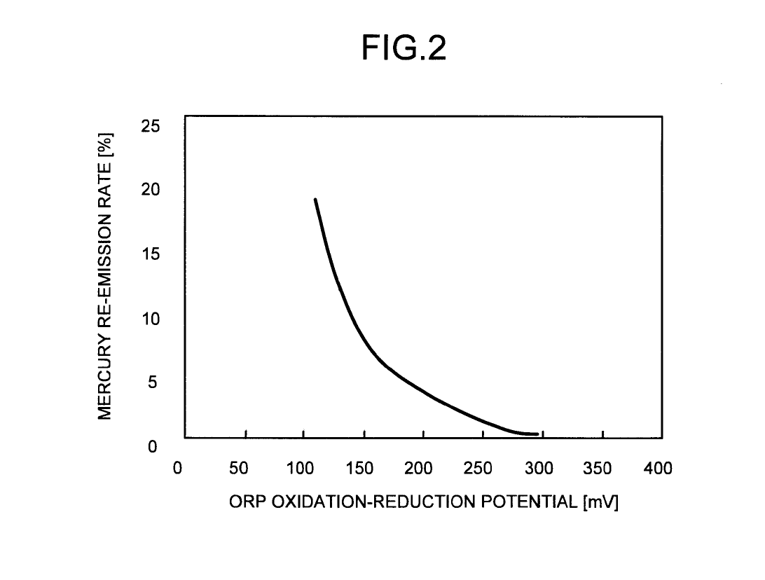

This is because the mercury re-emission rate can be reduced dramatically when the oxidation-reduction potential is equal to or more than 150 millivolts, preferably equal to or more than 175 millivolts, and more preferably equal to or more than 200 millivolts, as shown in the graph in FIG. 2 indicating the relationship between “the mercury re-emission rate (%) and the ORP oxidation-reduction potential (mV)”. The mercury re-emission rate (%) is obtained in the following formula:

Mercury Re-Emission Rate (%)=(Hg⁰ Out−Hg⁰ In)/(Hg²⁺ In)×100

As the oxidant, it is preferable to use an oxidant with a higher oxidation power than oxygen (air) used for a general ORP control, such as ozone (O₃), hydrogen peroxide (H₂O₂), potassium permanganate (KMnO₄), or a chlorine-based compound (for example, sodium hypochlorite (NaClO)), although the present invention is not limited thereto.

Furthermore, a manganese compound (KMnO₄, MnCl₂) may be added as a catalyst for promoting oxidoreduction.

As described above, according to the embodiment, the potential at the ORP meter is kept equal to or more than 150 millivolts to prevent the reduction of mercury oxide (Hg²⁺) (Hg²⁺→Hg⁰) and to suppress the re-emission of the zero-valent mercury) (Hg⁰) to the gaseous phase, whereby the reduction rate of mercury contained in the flue gas is improved.

Furthermore, the oxidant is added, and the manganese compound is added as required, to maintain the oxidization. Thus, the potential at the ORP meter can be advantageously kept equal to or higher then a predetermined level.

### INDUSTRIAL APPLICABILITY

As described above, the air pollution control system and the air pollution control method according to the present invention can improve the mercury reduction efficiency because the mercury re-emission is reduced, making it suitable for controlling air pollution when a restriction is imposed on the amount of emission of mercury contained in the flue gas.

1. An air pollution control system for a coal combustion boiler comprising:
a NOx removing apparatus that removes nitrogen oxide contained in flue gas emitted from the coal combustion boiler;
an air pre-heater that recovers heat in the gas after the nitrogen oxide is removed;
a precipitator that reduces particulates from the gas after the heat is recovered;
a liquid-gas contact type SOx removing apparatus that removes sulfur oxide by way of a limestone-gypsum method and reduces mercury oxide in the gas after the particulates are reduced; and
a stack that releases gas after SOx removal, wherein
an oxidant is added to limestone-gypsum containing slurry.

2. The air pollution control system for a coal combustion boiler according to claim 1, wherein the oxidant is one of or any combination of a manganese compound, ozone, hydrogen peroxide, and a chlorine-based compound, and an oxidation-reduction potential is equal to or more than 150 millivolts.

3. An air pollution control method for a coal combustion boiler by using a liquid-gas contact type SOx removing apparatus that removes sulfur oxide by way of a limestone-gypsum method and reduces mercury oxide contained in flue gas emitted from the coal combustion boiler, the air pollution control method comprising:
adding an oxidant to limestone-gypsum containing slurry.

4. The air pollution control method for a coal combustion boiler according to claim 3, wherein the oxidant is one of or any combination of a manganese compound, ozone, hydrogen peroxide, and a chlorine-based compound, and an oxidation-reduction potential is equal to or more than 150 millivolts.
